(19) United States
(12) Patent Application Publication
(10) Pub. No.: US 2009/0323656 A1
(43) Pub. Date: Dec. 31, 2009

(54) CIRCUIT-SWITCHED AND MULTIMEDIA SUBSYSTEM VOICE CONTINUITY

(75) Inventor: Kaniz Mahdi, Carrollton, TX (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent, PQ (CA)

(21) Appl. No.: 12/443,556

(22) PCT Filed: Oct. 4, 2007
(86) PCT No.: PCT/IB07/02954

§ 371 Date: Mar. 30, 2009

Related U.S. Application Data
(60) Provisional application No. 60/849,391, filed on Oct. 4, 2006.

(51) Int. Cl. H04W 40/00; H04L 12/66

(52) U.S. Cl. 370/338; 370/352

(57) ABSTRACT

The present invention relates to moving session control for a user element from a circuit-switched subsystem, such as a cellular network, to a multimedia subsystem (MS), such as the Internet Protocol (IP) Multimedia Subsystem (IMS). Session control is provided by the MS irrespective of whether the user element is using cellular or local wireless access for the sessions. Notably, multiple sessions may be controlled for a given user element at the same time. Session control for originating and terminating multiple simultaneous sessions in the CS or MS as well as transferring these sessions between the CS and MS is anchored at a continuity control function (CCF) in the MS. All session signaling for each of the multiple sessions is passed through the CCF. The CCF is a service provided in the MS, and anchors the user element's sessions as well as enables domain transfers between the CS and MS.

This application is a 35 USC 371 national phase filing of International application number PCT/IB2007/002954 filed Oct. 4, 2007, which claims the benefit of U.S. provisional patent application No. 60/849,391, filed on Oct. 4, 2006, the disclosures of which are incorporated herein by reference in their entireties.

### FIELD OF THE INVENTION

The present invention relates to communications, and in particular to providing a centralized control function for supporting sessions over circuit-switched subsystems and packet subsystems as well as effecting transfers of multiple established sessions from one subsystem to another.

### BACKGROUND OF THE INVENTION

Packet communications have evolved to a point where voice sessions, or calls, can be supported with essentially the same quality of service as that provided by circuit-switched communications. Packet communications are generally supported over packet subsystems, which were initially supported by local area networks, but are now supported by wireless local area networks (WLANs) and the like. Using WLAN access, user elements can support voice sessions using packet communications while moving throughout the WLAN. As such, WLAN access provides users the same freedom of movement within a WLAN as cellular access provides users within a cellular environment.

In many instances, the coverage areas provided by WLANs and cellular networks are complementary. For example, a WLAN may be established within a building complex in which cellular coverage is limited. Given the localized nature of WLAN coverage, cellular networks could bridge the coverage gaps between WLANs. Unfortunately, WLAN access technology has traditionally been independent of cellular access technology. Cellular networks have generally supported circuit-switched communications, and WLANs generally support packet communications. As such, user elements have been developed to support both cellular and WLAN communications using different communication interfaces. With these user elements, users can establish sessions via both the cellular network and WLAN using the respective communication interfaces; however, sessions established via the cellular network are not easily transferred to the WLAN, and vice versa. Further, when sessions are transferred, there is at best limited ability to maintain control over the session and to provide services associated with the session.

In an effort to address these issues, commonly assigned U.S. patent application Ser. No. 11/378,776, filed Mar. 17, 2006, and entitled CIRCUIT-SWITCHED AND MULTIMEDIA SUBSYSTEM VOICE CONTINUITY, provides a novel technique to effectively support a session for a user element over both cellular networks and WLANs as well as provide seamless transfers for the session between the respective networks. This technique also allows services associated with the session to be maintained after a transfer from one network to another. U.S. patent application Ser. No. 11/378,776, filed Mar. 17, 2006 is incorporated herein by reference in its entirety.

In particular, the disclosed technique moves service control, including session control, for a user element from a cellular network to a multimedia subsystem (MS), such as the Internet Protocol (IP) Multimedia Subsystem (IMS). As such, session control is provided by the MS irrespective of whether the user element is using cellular or WLAN (or like) access for the session. For clarity and conciseness, a cellular network providing circuit-switched communications is referred to as a circuit-switched subsystem (CS), and a WLAN or like wireless network providing packet communications is assumed to be part of or associated with the MS for purposes of description. Those skilled in the art will recognize that any number of packet networks may be employed to support the MS, WLAN, or other relevant packet-based networks.

Session control, including call control, for originating and terminating sessions in the CS or MS as well as transferring sessions between the CS and MS is anchored at a continuity control function (CCF) in the MS. All session signaling for the session is passed through the CCF. The CCF is a service provided in the MS, and anchors the user element's current CS supported sessions or MS supported sessions to enable mobility across the CS and MS. Notably, the terms “session” and “sessions” are deemed to cover any type of circuit-switched or packet-based communication sessions, including voice, data, audio, or video sessions.

For CS supported sessions, the CCF may anchor the bearer path for sessions originated or terminated in the CS by the user element at a media gateway, which may be controlled by a media gateway controller of the MS. For MS supported sessions, the CCF provides session control by interacting with the user element and a remote endpoint to establish a bearer path directly between the user element and the remote endpoint through the MS. The CCF is addressable using public service identities (PSI), which may take the form of directory numbers, uniform resource locators, or like addresses. In the CS, a directory number PSI associated with the CCF may be used for routing session signaling messages within the CS. In the MS, a PSI URL associated with the CCF may be used for routing session signaling messages within the MS.

Subsystem transfers enable the user element to move between the CS and the MS while maintaining one or more active sessions. Session transfers associated with a given session, including initial and subsequent transfers, are executed and controlled in the MS by the CCF, generally upon a request received from the user element. To enable such transfers, the CCF is inserted into the signaling path of the sessions by a serving call/session control function (S-CSCF). To anchor the signaling path, the CCF may employ a back-to-back user agent function, which operates as follows. When the user element originates a session, the CCF will terminate an access signaling leg from the user element and establish a remote signaling leg toward the remote endpoint. When terminating a session at the user element, the CCF will terminate a remote signaling leg from the remote endpoint and establish an access signaling leg toward the user element. Subsequently, the CCF will coordinate, or interwork, session signaling between the access signaling leg and the remote signaling leg for the session.

When the user element is originating a session, the CCF may appear as a service provided by an application server. In one embodiment, the CCF is invoked as the first service in a chain of services. When the user element is terminating a session, the CCF is invoked as the last service in a chain of services. By locating the CCF with respect to the other services in this manner, other applications associated with the session are anchored by the CCF as part of the remote signaling leg of the session, and are therefore not impacted by transfers affecting the access signaling leg.

Upon detecting conditions requiring a transfer, the user element will establish an access signaling leg with the CCF using the CS or MS based address for the CCF. The access signaling leg is established via the “transferring-in” subsystem to request a transfer to the transferring-in subsystem. The CCF will execute a subsystem transfer procedure by replacing the access signaling leg currently communicating with the remote signaling leg with the access signaling leg established via the transferring-in subsystem. The CCF will subsequently release the access signaling leg that was established through the “transferring-out” subsystem.

The switch of the access signaling legs from the transferring-out subsystem to the transferring-in subsystem does not impact the remote signaling leg or the application services in the remote signaling leg. Through the access signaling leg in the transferring-in subsystem and the remote signaling leg, the appropriate bearer path may be established to the user element via the appropriate CS client or MS client. Since all session signaling is provided through the CCF, additional services may be associated with the session through any number of transfers.

In many instances, a user element may support multiple sessions at the same time in the same domain. When the user element transfers from one domain to another domain, such as from the CS to the MS and vice versa, it is desirable to transfer each of the multiple sessions from the transferring-out domain to the transferring-in domain and maintain session continuity across the domain transfer. Accordingly, there is a need for a technique to transfer multiple simultaneous sessions between domains in association with a domain transfer while maintaining service continuity.

### SUMMARY OF THE INVENTION

The present invention relates to moving session control for a user element from a circuit-switched subsystem, such as a cellular network, to a multimedia subsystem (MS), such as the Internet Protocol (IP) Multimedia Subsystem (IMS). Session control is provided by the MS irrespective of whether the user element is using cellular or local wireless access for the sessions. Notably, multiple sessions may be controlled for a given user element at the same time. Session control for originating and terminating multiple simultaneous sessions in the CS or MS as well as transferring these sessions between the CS and MS is anchored at a continuity control function (CCF) in the MS. All session signaling for each of the multiple sessions is passed through the CCF. The CCF is a service provided in the MS, and anchors the user element's sessions as well as enables domain transfers between the CS and MS.

Upon detecting conditions requiring a domain transfer, the user element may initiate the domain transfer for multiple sessions from a transferring-out domain to a transferring-in domain via the transferring-in domain. New access signaling legs for each of the multiple sessions are established via the transferring-in domain in association with a request to transfer the multiple sessions to the transferring-in domain. The CCF will execute a subsystem transfer procedure by replacing each of the old access signaling legs of the transferring-out domain with the corresponding new access signaling legs that were established via the transferring-in domain. The access signaling legs in the transferring-in domain are then interworked with the corresponding remote signaling legs for the multiple sessions by the CCF. The CCF will subsequently release the old access signaling legs that were established through the transferring-out domain.

For CS access, access signaling legs extending into the CS toward the user element may extend through a remote user agent, which presents itself as the user element to elements in the MS. Depending on the signaling capabilities of the CS, the remote user agent may interact substantially directly with the user element or through a CS Access Adaptation Function (CAAF), which acts as a liaison between the MS and CS to convert session signaling into the proper format for the respective subsystems.

Each of the multiple sessions may have an associated bearer path. The portions of the bearer paths that are not in the CS are preferably separate from one another. However, for the sessions that are supported in part by the CS, a common CS bearer portion may be shared by each of the bearer paths. When the common CS bearer portion is shared, the portions of the bearer paths in the MS may remain separate.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a communication environment illustrating circuit-switched subsystem access for a user element according to an embodiment where a single session is supported.

FIG. 2 is a communication environment illustrating multimedia subsystem access for a user element according to an embodiment where a single session is supported.

FIG. 3 is a communication environment illustrating circuit-switched subsystem access for a user element according to an embodiment where the signaling path for control of a CS portion of the bearer path is supported.

FIG. 4 is a communication environment illustrating circuit-switched subsystem access for a user element according to an embodiment of the present invention where multiple sessions are supported.

FIG. 5 is a communication environment illustrating multimedia subsystem access for a user element according to an embodiment of the present invention where multiple sessions are supported.

FIGS. 6A and 6B provide a communication flow illustrating the transfer of a session from the CS to the MS according to one embodiment of the present invention.

FIGS. 7A through 7C provide a communication flow illustrating the transfer of a session from the MS to the CS according to one embodiment of the present invention.

FIG. 8 is a communication environment illustrating circuit-switched subsystem access for a user element according to an alternative embodiment of the present invention where multiple sessions are supported.

FIG. 9 is a communication environment illustrating multimedia subsystem access for a user element according to an alternative embodiment of the present invention where multiple sessions are supported.

FIGS. 10A through 10C provide a communication flow illustrating the transfer of a session from the MS to the CS according to an alternative embodiment of the present invention.

FIG. 11 is a block representation of a service node according to one embodiment of the present invention.

FIG. 12 is a block representation of a user element according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The following description initially provides an exemplary overview of both CS access and MS access for a user element that is engaged in a single session. The bearer and signaling paths of the single session for both CS access and MS access are described, along with an overview of domain transfers between the CS and MS domains when the single session is being transferred from one domain to another. Next, an overview of both CS access and MS access is provided when the user element is engaged in multiple sessions, according to one embodiment of the present invention. The bearer and signaling paths for each of the multiple simultaneous sessions are described, along with an overview of domain transfers between the CS and MS domains when multiple sessions are being transferred together. Detailed communication flows are then provided to illustrate exemplary domain transfer procedures between the CS and MS domains when multiple simultaneous session are involved according to select embodiments of the present invention. Finally, an alternative CS access technique is described along with a corresponding communication flow, which illustrates an available domain transfer procedure when multiple sessions are being transferred.

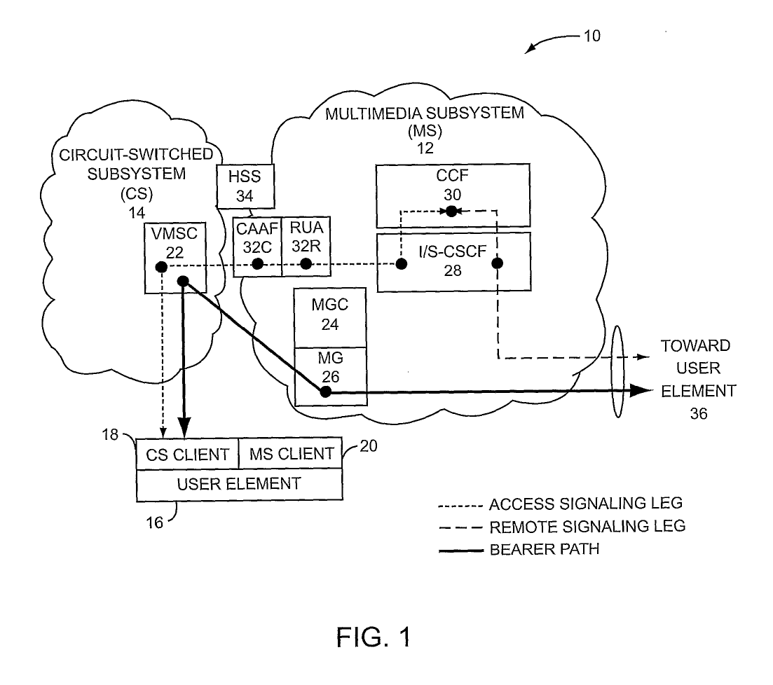

Turning now to FIG. 1, a communication environment 10 is illustrated according to one embodiment of the present invention. In the communication environment 10, an MS 12 and a visited CS 14 support communications for a user element 16. The MS 12 may be the home network for the user element 16. The user element 16 may include a CS client 18 and an MS client 20, which are configured to support circuit-switched communications via the CS 14 as well as packet communications via the MS 12, respectively. For communications within the CS 14, a visited mobile switching center (VMSC) 22 will support circuit-switched communications for the user element 16. The VMSC 22 may interact with the MS 12 via a media gateway controller (MGC) 24 and an associated media gateway (MG) 26, both of which are affiliated with the MS 12.

The MS 12 may include various functions or entities, including interrogating and serving call/session control functions (I/S-CSCF) 28, a CCF 30, a remote user agent (RUA) 32R, a CAAF 32C, and a home subscriber service (HSS) 34. Notably, the interrogating CSCF provides the standard I-CSCF functions and the serving CSCF provides standard S-CSCF functions. These functions, which are often separate, are represented in the I/S-CSCF 28 for conciseness. Further, the HSS 34 may have a presence in both the CS 14 and the MS 12. The HSS 34 may include a home location resource (HLR) component for a home CS. Call/session control functions (CSCFs) in the MS 12 generally act as session initiation protocol (SIP) or like proxies and provide various functions in association with session control, as will be appreciated by those skilled in the art. In operation, an interrogating CSCF (I-CSCF) may interact with the HSS 34 to identify the serving CSCF (S-CSCF), which will be assigned to support a given user element. The HSS 34 may maintain an association between a user element 16 and a particular CCF 30 that is assigned to the user element 16. As such, the HSS 34 may assist in identifying a serving CSCF for the user element 16, as well as keep an association between a particular CCF 30 and the user element 16. The CCF PSI for the user element 16 that is used to gain access to the CCF 30 may be provisioned in the user element 16 to enable the user element 16 to initiate transfers and the like control by the CCF 30. Alternatively, the CCF PSI may be transferred to the user element 16 upon network registration or at any other time.

The HSS 34 may store filter criteria associated with the CCF 30 as part of the user element's subscription profile. The CCF filter criteria is downloaded to the currently assigned I/S-CSCF 28 as part of the initial filter criteria to use when the user element 16 registers with the MS 12. This filter criteria is generally executed at the I/S-CSCF 28 upon initiation of a session from the user element 16 or upon receipt of an incoming session intended for the user element 16. This filter criteria may instruct the I/S-CSCF 28 to invoke the CCF 30 to control at least the bearer path for the session.

The RUA 32R may provide a remote user agent function in the MS 12 on behalf of the user element 16 for sessions supported by the CS 14. Thus, the RUA 32R represents itself as the user element 16 to the various components of the MS 12, such as the I/S CSCF 28, when the user element 16 is supported by the CS 14. The RUA 32R may work in close cooperation with the CAAF 32C, which provides an interface to the CS 14 and acts as a signaling liaison between the CS 14 and the RUA 32R. CS signaling from the CS 14 is received by the CAAF 32C and presented to the RUA 32R for delivery in an appropriate format, such as Session Initiation Protocol (SIP) signaling, within the MS 12. Similarly, MS signaling from the MS 12 is received by the RUA 32R and presented to the CAAF 32C for delivery in an appropriate format within the CS 14. At a high level, the CAAF 32C and the RUA 32R provide a signaling gateway and proxy function between the CS 14 and the MS 12 for sessions supported, at least in part, by the CS 14.

Application servers (not shown) may be invoked and placed within the session signaling path to implement any number of features or services. When a particular application service provided by an application server is invoked, all signaling for the associated session or sessions is passed through the application service, which has the opportunity to process session signaling messages as necessary to implement the desired service. Notably, the CCF 30 acts like a service, and as such, the I/S-CSCF 28 will operate to pass all session signaling messages for the session through the CCF 30, thereby allowing the CCF 30 to act as an anchor for the session.

In FIG. 1, the user element 16 is engaged in a session supported by the CS client 18 and controlled by the CCF 30. As such, session signaling for the session passes through the VMSC 22, CAAF 32C, RUA 32R, I/S-CSCF 28, CCF 30, and perhaps an application server, if a service is invoked, on its way toward a remote user element 36. Notably, the access signaling leg, which is provided by the CS 14, is anchored at the CCF 30 and extends through the I/S-CSCF 28, RUA 32R, CAAF 32C, VMSC 22, and CS client 18 of the user element 16. The remote signaling leg toward the remote user element 36 is anchored in the CCF 30 and extends through the I/S-CSCF 28 and any application server that have been invoked. In this configuration, the CCF 30 can maintain control of the session and provide any necessary session processing during the session. Further, if a session transfer is required, the CCF 30 maintains the remote signaling leg and establishes a new access signaling leg with the user element 16 via the transferring-in domain.

The bearer path for the session illustrated in FIG. 1 extends from the CS client 18 through the VMSC 22 and media gateway 26 on its way toward the remote user element 36. Notably, the media gateway controller 24 cooperates with the media gateway 26, such that a circuit-switched connection may be established between the media gateway 26 and the CS client 18 via the VMSC 22. The packet session may be established for the session from the media gateway 26 through the MS 12 toward the remote user element 36.

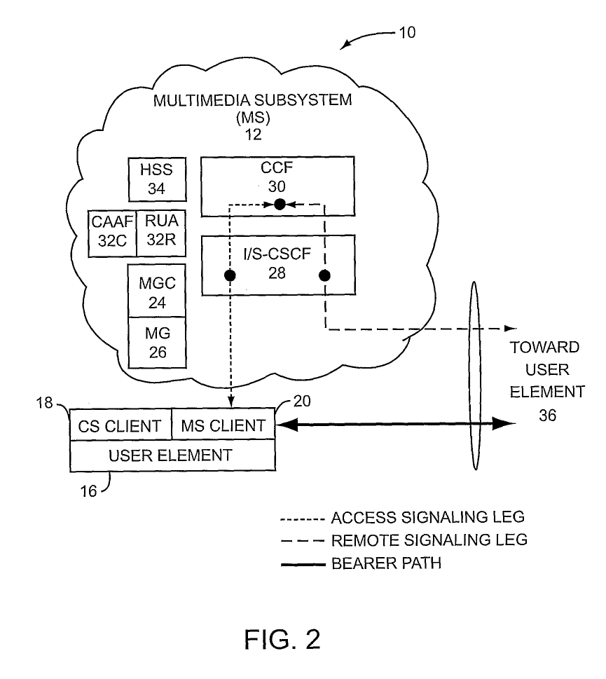

With reference to FIG. 2, a session supported by the MS client 20 of the user element 16 is represented. Notably, the session does not extend through the CS 14, and will not employ the services of the VMSC 22, CAAF 32C, RUA 32R, media gateway controller 24, or media gateway 26. Instead, the MS client 20 will support session signaling directly with the MS 12, and in particular with the CCF 30 via the I/S-CSCF 28. Notably, different CSCFs may be used for access via different domains.

As illustrated, session signaling is anchored in the CCF 30, wherein an access signaling leg is provided between the CCF 30 and the MS client 20 via the I/S-CSCF 28. A remote signaling leg is supported between the remote user element 36 and the CCF 30 via the I/S-CSCF 28 and any desired application servers that may provide additional services in association with the session. The bearer path will extend from the MS client 20 toward the remote user element 36 via the MS 12, without traveling through the CS 14 (FIG. 1). Again, the CCF 30 anchors the session, such that if a transfer from one domain to another is required, the remote signaling leg toward the remote user element 36 can be maintained, while the access signaling leg may be changed to facilitate the transfer from the MS 12 to the CS 14, as will be described further below. For transfer of a session between the CS 14 and the MS 12, the access signaling legs illustrated in FIGS. 1 and 2, respectively, will be changed to support the transfer, while the remote signaling leg is maintained by the CCF 30.

In general, subsystem transfers enable the user element 16 to move between the CS 14 and the MS 12 while maintaining one or more active sessions, such as voice or other media. Session transfers associated with a given session, including initial and subsequent transfers, are executed and controlled in the MS 12 by the CCF 30, upon a request received from the user element 16. To enable such transfers, the CCF 30 is inserted into the signaling path of the sessions by the I/S-CSCF 28. To anchor the signaling path, the CCF 30 may employ a back-to-back user agent function (B2BUA), which may operate as follows. When the user element 16 originates a session, the CCF 30 will terminate an access signaling leg from the user element 16 and establish a remote signaling leg toward the remote user element 36. When a user element 16 terminates a session, the CCF 30 will terminate a remote signaling leg from the remote user element 36 and establish an access signaling leg toward the user element 16. Subsequently, the CCF 30 will coordinate session signaling between the access signaling leg and the remote signaling leg for the session.

When the user element 16 is originating a session, the CCF 30 may appear as a service provided by an application server. In one embodiment, the CCF 30 is invoked as the first service in a chain of services. When the user element 16 is terminating a session, the CCF 30 is invoked as the last service in a chain of services. By locating the CCF 30 with respect to the other services in this manner, other applications associated with the session are anchored by the CCF 30 as part of the remote signaling leg of the session, and are therefore not impacted by transfers affecting the access signaling leg.

Upon detecting conditions requiring a transfer, the user element 16 will establish an access signaling leg with the CCF 30 using the CS or MS based address for the CCF 30. The access signaling leg is established via the transferring-in subsystem to request a transfer to the transferring-in subsystem. The CCF 30 will execute a subsystem transfer procedure by replacing the access signaling leg currently communicating to the remote signaling leg with the access signaling leg established via the transferring-in subsystem. The CCF 30 will subsequently release the access signaling leg that was established through the transferring-out subsystem. The switch of the access signaling leg from the transferring-out subsystem to the transferring-in subsystem does not impact the remote signaling leg or the application services in the remote signaling leg. Through the access signaling leg in the transferring-in subsystem and the remote signaling leg, the appropriate bearer path may be established to the user element 16 via the appropriate CS client 18 or MS client 20. Since all session signaling is provided through the CCF 30, additional services may be associated with the session through any number of transfers.

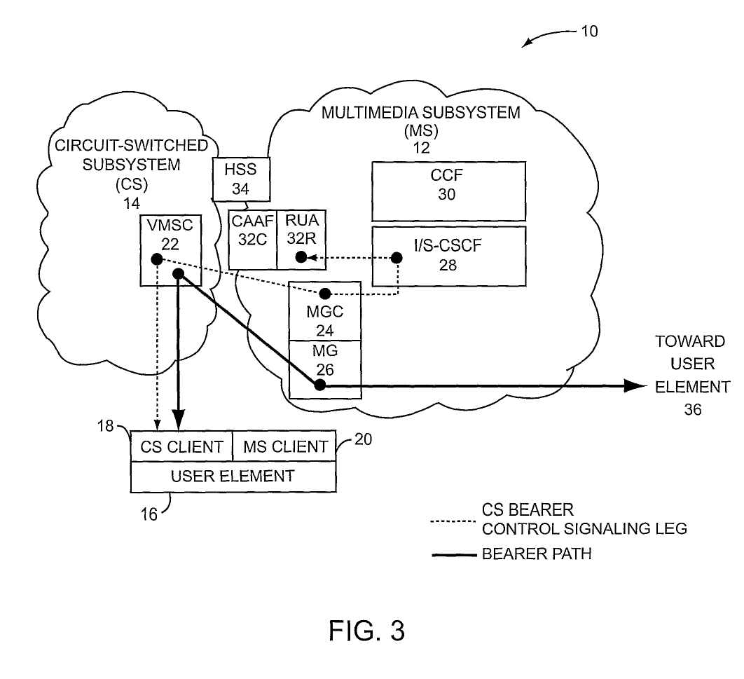

When a session is supported via the CS 14, a circuit-switched portion of the bearer path extends from the user element 16 through the VMSC 22 to the media gateway 26. The signaling associated with establishing and controlling this portion of the bearer path may extend between the user element 16 and the RUA 32R through the VMSC 22, media gateway controller 24, and I/S CSCF 28, as illustrated in FIG. 3. This allows the RUA 32A and VMSC 22 to effectively control the circuit-switched portion of the bearer path in cooperation with the packet-based portion of the bearer path that extends from the media gateway 26 toward the remote user element 36, when the session is supported by the CS 14.

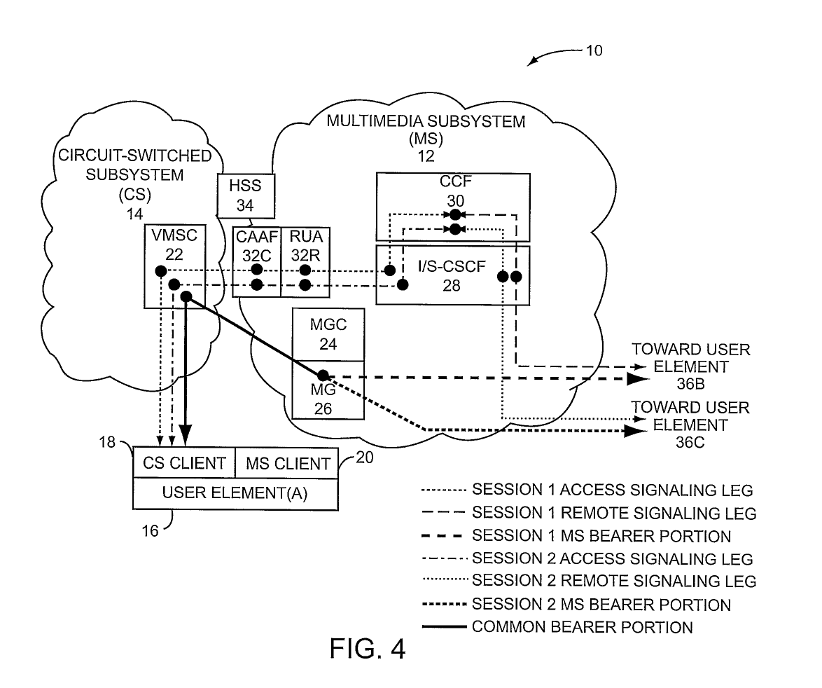

With the present invention, a given user element 16 may support multiple sessions at the same time, and when the user element 16 transfers from one domain to another, each of the multiple sessions are also transferred while maintaining continuity of the sessions. In FIG. 4, the user element 16 is engaged in two sessions, Session 1 and Session 2, which are both supported by the CS client 18 and anchored at the CCF 30, which controls the sessions. As such, session signaling for each session passes through the VMSC 22, CAAF 32C, RUA 32R, I/S-CSCF 28, CCF 30, and perhaps an application server, if a service is invoked, on its way toward a remote user element 36. Notably, the access signaling legs for each session is anchored at the CCF 30 and extends through the I/S-CSCF 28, RUA 32R, CAAF 32C, and CS client 18 of the user element 16. The remote signaling leg for each session is anchored in the CCF 30 and extends toward the respective remote user elements 36B and 36C through the I/S-CSCF 28 and any application server that have been invoked. In this configuration, the CCF 30 can maintain control of both sessions and provide any necessary session processing during the sessions. If a session transfer is required, the CCF 30 maintains the remote signaling legs and establishes new access signaling legs with the user element 16 via the transferring-in domain.

As illustrated, each session shares a common bearer path with the CS 14 and has a unique bearer path in the MS 12. In particular, a single or common CS bearer portion may extend from the CS client 18 through the VMSC 22 to the media gateway 26. Both sessions may share this common CS bearer portion, especially if both sessions are voice sessions. Within the MS 12, each session will have a unique MS bearer portion. As such, two MS bearer portions extend from the media gateway 26 toward respective remote user elements 36B and 36C. The media gateway 26 under control of the media gateway control function 24 will effectively interwork the single CS bearer portion with an appropriate one of the MS bearer portions depending on which session is active.

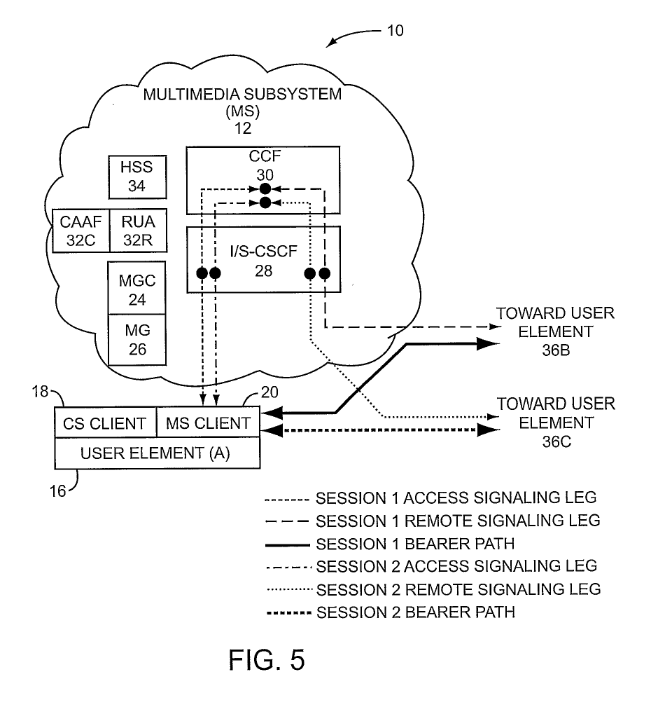

With reference to FIG. 5, both Session 1 and Session 2 are supported by the MS client 20 of user element 16. The sessions do not extend through the CS 14, and will not employ the services of the VMSC 22, CAAF 32C, RUA 32R, media gateway controller 24, or media gateway 26. Instead, the MS client 20 will support session signaling for both sessions directly with the MS 12, and in particular with the CCF 30 via the I/S-CSCF 28.

Again, session signaling is anchored in the CCF 30, wherein an access signaling leg for each session is provided between the CCF 30 and the MS client 20 via the I/S-CSCF 28. Remote signaling legs are supported between remote user elements 36B and 36C and the CCF 30 via the I/S-CSCF 28 and any desired application servers that may provide additional services in association with the session. Different bearer paths for the sessions will extend from the MS client 20 toward remote user elements 36B and 36C, respectively, via the MS 12, without traveling through the CS 14. Again, the CCF 30 anchors the session, such that if a transfer from one domain to another is required, the remote signaling legs toward remote user elements 36B and 36C are maintained, while the access signaling leg may be changed to facilitate the transfer from the MS 12 to the CS 14. For transfer of the sessions between the CS 14 and the MS 12, the access signaling legs illustrated in FIGS. 4 and 5 will be changed to support the transfer, while the remote signaling legs are maintained by the CCF 30.

As with single session transfers, multiple session transfers enable user element 16 to move between the CS 14 and the MS 12 while maintaining current sessions and the proper state for these sessions. Session transfers associated with each current session, including initial and subsequent transfers, are executed and controlled in the MS 12 by the CCF 30, upon a request received from user element 16. Again, the CCF 30 is inserted into the signaling path for each of the multiple sessions by the I/S-CSCF 28. To anchor the signaling path, the CCF 30 may employ a B2BUA for each session. The CCF 30 will coordinate session signaling between the access signaling leg and the remote signaling leg for each session.

Upon detecting conditions requiring a transfer, user element 16 will establish access signaling legs for the sessions with the CCF 30 using the CS or MS based address for the CCF 30. The access signaling legs are established via the transferring-in subsystem to request a transfer to the transferring-in subsystem. The CCF 30 will execute a subsystem transfer procedure by replacing the access signaling legs currently communicating to the remote signaling legs with the access signaling legs established via the transferring-in subsystem. The CCF 30 will subsequently release the access signaling legs that were established through the transferring-out subsystem. The switch of the access signaling legs from the transferring-out subsystem to the transferring-in subsystem for the multiple sessions does not impact the remote signaling legs or the application services in the remote signaling legs. Further details are provided in association with the following communication flows. The communication flows are provided for exemplary embodiments of the present invention and are not intended to limit the scope of the invention in any way. For these communication flows, the following principles apply.

Sessions established via a packet access network and outside of the CS 14 use standard IMS control procedures, such as those set forth by the Third Generation Partnership Project (3GPP). Each session will have its own signaling path and bearer path. As such, multiple sessions will require multiple signaling paths and multiple bearer paths. For example, a user element 16 engaged in two calls will require two sessions, each of which having a signaling path and a bearer path. All of the sessions are anchored in the CCF 30, and each signaling path for each session will have one access signaling leg and one remote signaling leg.

Sessions established via the CS 14 use a CS bearer portion for the portion of the bearer path that extends through the CS 14 to the MS 12. The RUA 32R presents session signaling for the sessions to the MS 12 as standard IMS sessions. Each session will have its own signaling path; however, each session may share a bearer path over the CS bearer portion of the bearer path that extends through the CS 14. Different MS bearer portions are provided through the MS 12. As such, multiple sessions will require multiple signaling paths and multiple bearer paths through the MS 12. Again as an example, a user element 16 engaged in two calls will require two sessions, each of which having a signaling path and a bearer path. Both sessions are anchored at the CCF 30, and each signaling path for each session will have one access signaling leg and one remote signaling leg. In these embodiments, although there may be multiple non-voice sessions active for a user element 16, only one voice session is active at any time, given the feasibility of a single user carrying on two conversations at once.

Session establishment and updating for a domain transfer is similar to session establishment upon initially setting up a session. The access signaling legs for all of the sessions present in the transferring-out domain at the time of a domain transfer are updated at the CCF 30 with information from the transferring-in domain. This helps to ensure proper control of the current sessions after the domain transfer, and that control for the current sessions is consistent with any new sessions that are established after a domain transfer.

Further, establishment of a bearer path for sessions that are on hold, which are referred to as held sessions, is not required for completion of the domain transfer procedure. From a user perspective, the domain transfer procedure is deemed complete after successful establishment of the bearer path for an active session, which effectively restores service for the active session. The access signaling leg in the transferring-out domain for a held session may be released any time after the corresponding access signaling leg in the transferring-in domain has been updated with information from the transferring-in domain. Establishment of the bearer path for a held session in the transferring-in domain may be deferred until after the release of the access signaling leg in the transferring-out domain, or until the held session is resumed. Notably, although there may not be any real time protocol (RTP) information present over the bearer path in a held session, real time control protocol (RTCP) signaling over the bearer path may be required. If RTCP signaling over the bearer path is required for a held session, the bearer path may be maintained in the transferring-out domain until the bearer path in the transferring-in domain is established and the held session is resumed.

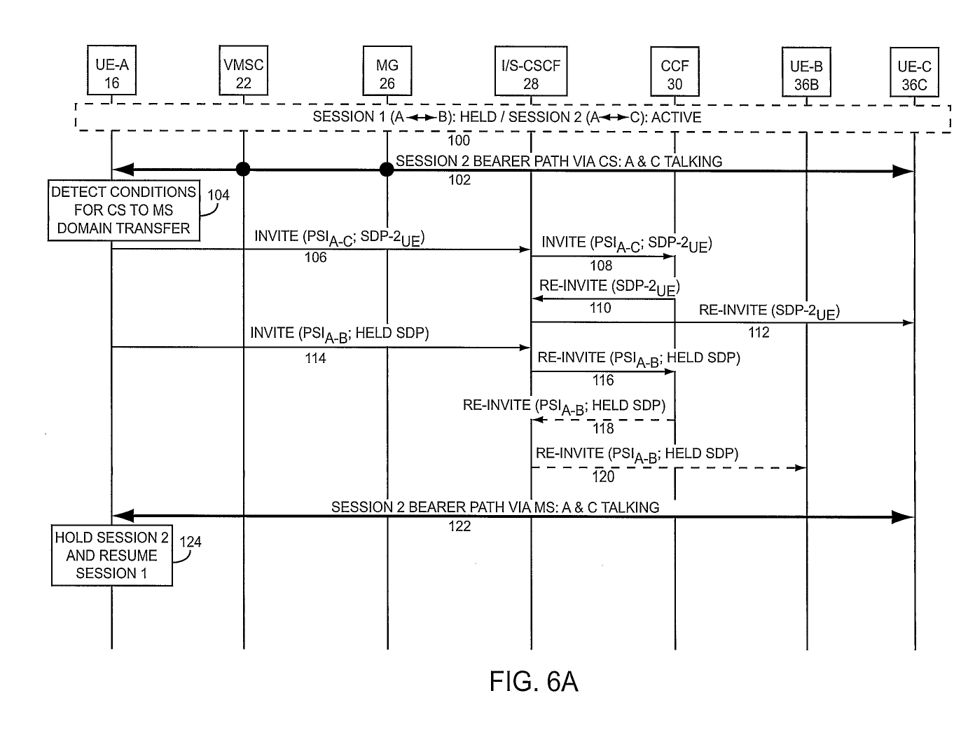

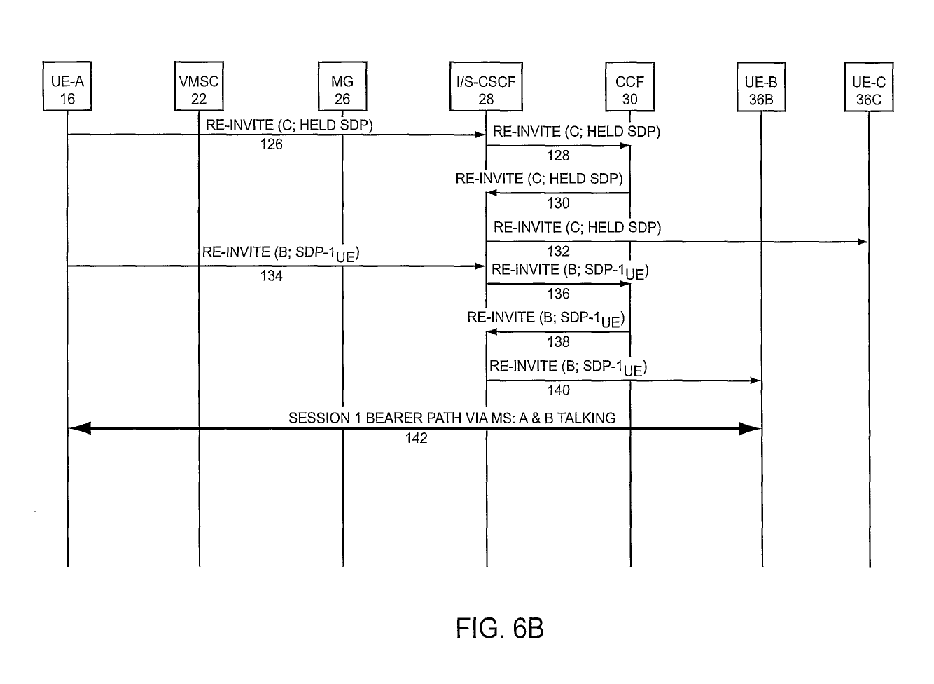

With reference to FIGS. 6A and 6B, a communication flow is provided to illustrate a domain transfer from the CS 14 to the MS 12. Initially, user element 16 (UE-A) is engaged in a first session, Session 1, with user element 36B (UE-B) and in a second session, Session 2, with remote user element 36C (UE-C). For the purposes of this example only, assume that Session 1, the session between user element 16 and remote user element 36B, is held, and that Session 2, between user element 16 and remote user element 36C, is active (step 100). Further assume that both sessions are voice sessions supporting a telephony call with remote user elements 36B and 36C, respectively. The bearer path for Session 2, which extends to user element 16 through the CS 14, is illustrated as extending between user element 16 and remote user element 36C through the VMSC 22 and the media gateway 26 (step 102). The media for Session 1 is held, and other than in-band signaling, no media is being exchanged between user element 16 and remote user element 36B.

At some point, user element 16 may detect conditions requiring a domain transfer from the CS 14 to the MS 12 (step 104). In other words, the CS access currently supporting wireless communications with user element 16 should be transferred to packet access through a packet access network associated with the MS 12. User element 16 may monitor conditions of the different access networks and make the determination alone or in association with serving base stations, access points, or the like. Preferably, user element 16 will initiate the transfer of active sessions prior to inactive or held sessions. To initiate the domain transfer for Session 2, which is the active session, user element 16 may send an Invite message into the MS 12 intended for the CCF 30. Notably, the Invite message is not sent into the MS 12 through the CS 14, but instead through the packet access network associated with the MS 12. In this instance, the CS 14 is the transferring-out domain and the MS 12 is the transferring-in domain.

The Invite message is addressed using a PSI (PSI_{A-C}) for the CCF 30 and is sent to the I/S-CSCF 28 (step 106), which will forward the Invite message to the CCF 30 (step 108). The PSI may be associated with a unique session or some other method may be employed to identify the session for which the transfer is being requested. Those skilled in the art will recognize other techniques for identifying the session, such as using a separate session ID in conjunction with a PSI that is common to multiple sessions. The Invite message may include the Session Data Protocol (SDP) for Session 2 (SDP-2_{UE}). This SDP identifies the communication parameters necessary for remote user element 36C to use when communicating with user element 16 through the MS 12 instead of through the CS 14. The CCF 30 will recognize the Invite message as a request for a domain transfer to the MS 12, and as such will send a Re-Invite message with the new SDP-2_{UE} toward remote user element 36C via the I/S-CSCF 28 (steps 110 and 112). The Re-invite message delivered to remote user element 36C will effectively instruct remote user element 36C to communicate with user element 16 directly via the MS 12 instead of indirectly via the media gateway 26. Throughout this process, user element 16 may maintain the session state information across the domain transfer, and provide an update of the state information, if necessary, to the CCF 30. Similarly, the CCF 30 may also provide state information to user element 16, if so desired.

From the above, upon detecting a need for a domain transfer, user element 16 initiated the domain transfer by sending an Invite message via a new access signaling leg in the transferring-in domain to the CCF 30, which will provide an appropriate update over the remote signaling leg to remote user element 36C to facilitate transitioning of the bearer path for Session 2 from the CS 14 to the MS 12. Notably, the access signaling leg from the CCF 30 to user element 16 changes from the CS 14 to the MS 12, while the remote access signaling leg remains intact. The requisite acknowledgements and additional signaling may flow between user element 16 and remote user element 36C over the new access signaling path and the existing remote signaling path. The access signaling leg through the CS 14 is subsequently released.

In a similar fashion, Session 1, which is held in this example, is transferred simultaneously with or after the transfer of Session 2, which is the active session. Again, an Invite message is sent toward the CCF 30 through the MS 12. Notably, the new access signaling leg established through the MS 12 for Session 1 is different from the access signaling leg for Session 2. The domain transfer procedure maintains symmetry of the access signaling legs for current sessions between the transferring-out and transferring-in domains. If there are two access signaling legs in the transferring-out domain, there will be two access signaling legs in the transferring-in domain. As such, the Invite message sent from user element 16 is received by the I/S-CSCF 28 over an access signaling leg associated with Session 1 (step 114). The I/S-CSCF 28 will forward the Invite message to the CCF 30 (step 116). The Invite message may include an indication, perhaps in the SDP, that the session is being held. As such, the CCF 30 may identify the session as being held and determine whether to provide an update to remote user element 36B over the corresponding remote signaling leg for Session 1.

Since Session 1 is being held, there may not be an immediate need to update remote user element 36B of the change in domains for user element 16, because there is no active media being exchanged between user element 16 and remote user element 36B. However, such an update must be provided before Session 1 becomes active or is otherwise resumed. Thus, the dashed lines associated with steps 118 and 120 reflect the CCF 30 providing an update to remote user element 36B indicating that there has been a domain transfer. In this example, the SDP indicates that the session remains held. At this point, Session 1 remains held and Session 2 remains active. The bearer path for Session 2 extends directly between user element 16 and remote user element 36C via the MS 12 or associated packet network (step 122). Throughout these domain transfers, each session will include a separate signaling path, which will include an access signaling path and a remote signaling path. To effect a transfer, a new access signaling path is provided in the transferring-in domain and the old access signaling path from the transferring-out domain is released. The CCF 30 will take the necessary steps to store information identifying the proper access signaling leg and remote signaling leg for a given session, and ensure that signaling messages are passed between the appropriate access and remote signaling legs to facilitate session control, and importantly, to maintain continuity across domain transfers.

Next, assume that the user associated with user element 16 takes the necessary action to resume Session 1 and place Session 2 on hold (step 124). In response, user element 16 will send a Re-invite message over the access signaling path in the MS 12 toward the CCF 30 via the I/S-CSCF 28 (steps 126 and 128). The Re-invite message will identify the session or the remote party associated with the session (C), as well as provide an indication that Session 2 is being held. In this example, the SDP will indicate that the session is being held. The CCF 30 may make note of the call status and forward the Re-invite message toward remote user element 36C through the I/S-CSCF 28 to indicate that the session is being held by user element 16 (steps 130 and 132). After the appropriate acknowledgements, Session 2 between user element 16 and remote user element 36C is held. In the meantime, user element 16 will send a Re-invite message toward the CCF 30 via the MS 12 to resume Session 1 (steps 134 and 136). The Re-invite message will identify Session 1 or remote user element 36B, and will provide the SDP (SDP-1_{UE}) as necessary for communicating with user element 16. The SDP may be the same or different than that used for communications with remote user element 36C. The CCF 30 will make note of the session state and provide an update to remote user element 36B by sending a Re-Invite message toward remote user element 36B through the I/S-CSCF 28 (steps 138 and 140). At this point, Session 1 is active and supported by a bearer path that extends between user element 16 and remote user element 36C through the MS 12 or associated packet network, without going through the CS 14 (step 142). Notably, the resources initially allocated to Session 2 may be reused when Session 1 is resumed and Session 2 is held.

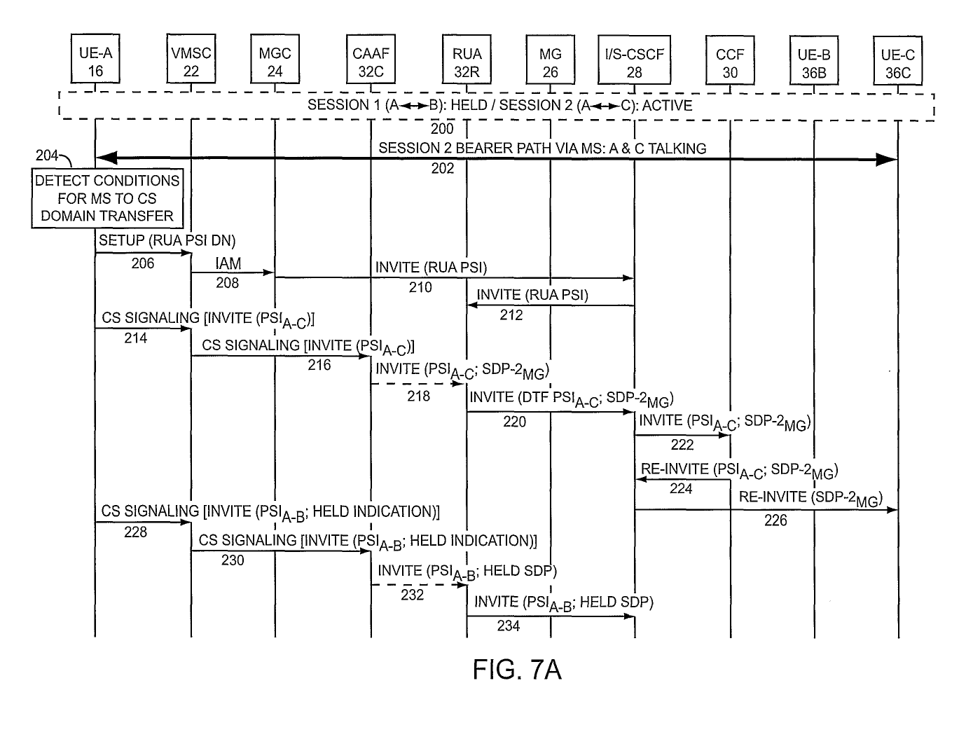

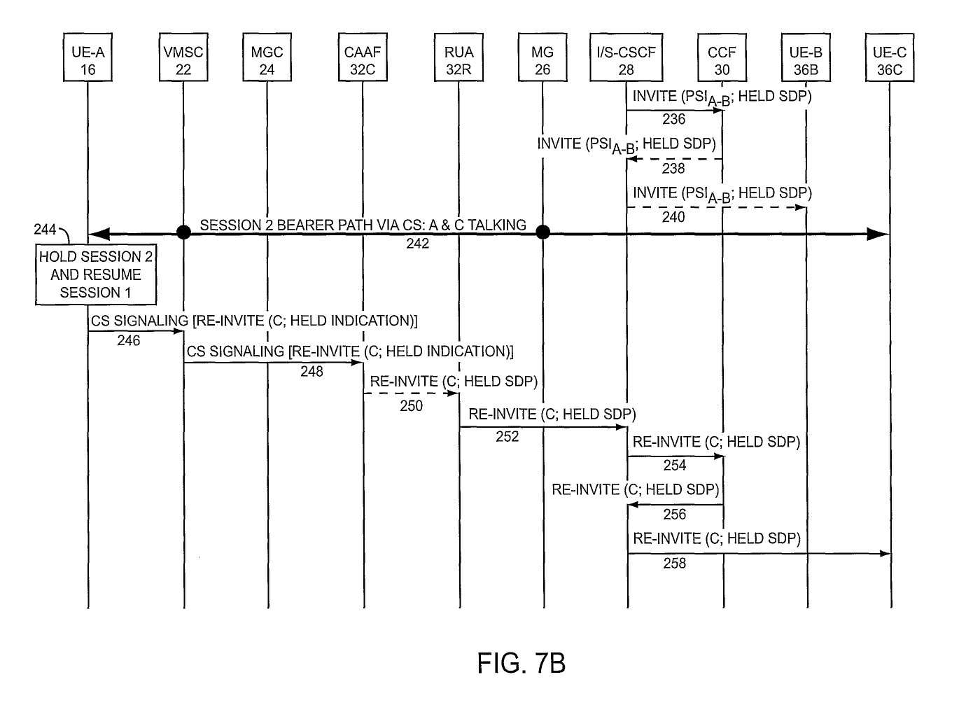

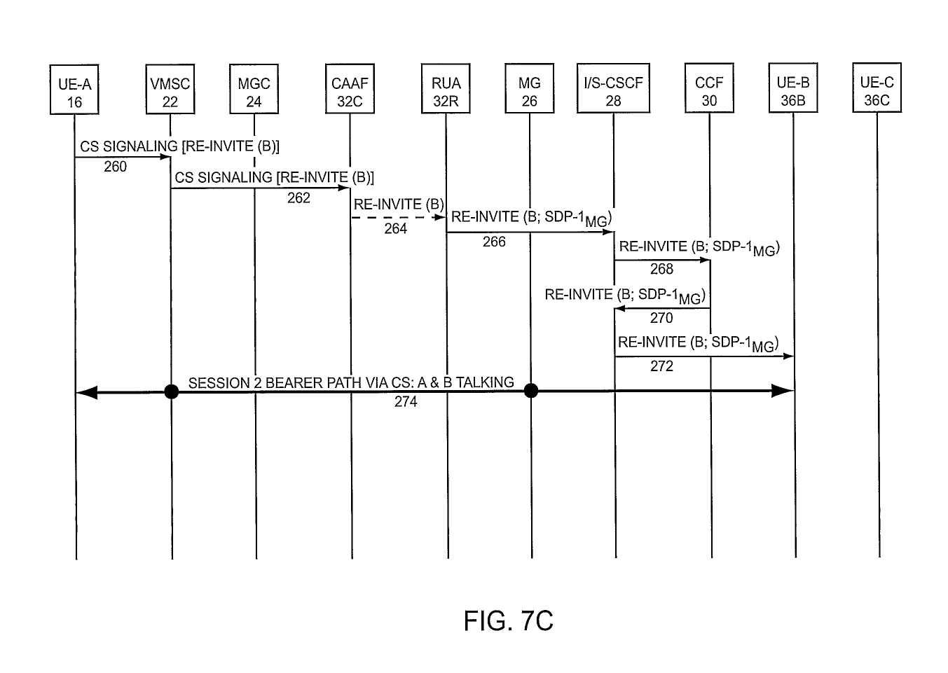

With reference to FIGS. 7A-7C, an exemplary communication flow is provided for facilitating a domain transfer from the MS 12 to the CS 14. The MS 12 will represent the transferring-out domain, and the CS 14 will represent the transferring-in domain. Again, assume that Session 1 is a session extending between user element 16 (UE-A) and remote user element 36B (UE-B) and is being held. Session 2 is active and extends between user element 16 (UE-A) and remote user element 36C (UE-C) (step 200). However, both of these sessions have or will have bearer paths that extend directly through the MS 12 or a packet network associated therewith without traversing the CS 14. As such, the active session, Session 2, has a bearer path that extends through the MS 12 between user element 16 and remote user element 36C (step 202). When user element 16 detects conditions for a domain transfer from the MS 12 to the CS 14 (step 204), user element 16 will send a Setup message to the VMSC 22 to trigger establishment of a CS bearer portion from user element 16 to the media gateway 26 via the CS 14 (step 206). The Setup message may be directed to a directory number (DN) associated with the RUA 32R, wherein the DN represents a PSI for the RUA 32R. In response to receiving the Setup message, the VMSC 22 will send an Initial Address Message (IAM) to the media gateway controller 24 that controls the media gateway 26 (step 208). The media gateway controller 24 and the VMSC 22 will exchange various Integrated Services User Part (ISUP) messages, as those skilled in the art will recognize, to establish a CS bearer portion between user element 16 and the media gateway 26 via the VMSC 22. The media gateway controller 24 will also send a corresponding Invite message toward the RUA 32R via the I/S-CSCF 28 (steps 210 and 212). The Invite message is addressed to a PSI associated with the RUA 32R and is intended to alert the RUA 32R of the CS bearer portion and prepare the RUA 32R for acting on behalf of user element 16 while user element 16 is being served by the CS 14.

Preferably, user element 16 will initiate the transfer of the active session, Session 2, first. To trigger a transfer from the MS 12 to the CS 14, user element 16 may generate an Invite message to be delivered to the CCF 30. As with the previous communication flow, user element 16 may keep track of state information associated with the sessions, and provide such state information for the session being transferred in the Invite message. Since the Invite message cannot be sent directly over the CS 14 into the MS 12, the Invite message or information for the Invite message must be delivered over the CS 14 and to the RUA 32R. In this example, CS signaling traditionally used in the CS 14 is used to carry the Invite message to the VMSC 22 (step 214), which will forward the Invite message or information for the Invite message and further CS signaling to the CAAF 32C (step 216). The CAAF 32C can extract the Invite message or information for the Invite message from the CS signaling and cooperate with the RUA 32R to provide an Invite message for delivery into the MS 12 (step 218). In this example, an Unstructured Supplementary Service Data (USSD) signaling channel is available between user element 16 and the CAAF 32C via the VMSC 22. USSD messages may include a signaling envelope, in which the Invite message or information for the Invite message is carried from user element 16 to the CAAF 32C. Notably, various envelopes may be used to carry various signaling information between user element 16 and the CAAF 32C while user element 16 is being served by the CS 14.

As illustrated, the CAAF 32C and RUA 32R will alone or together recognize that the CS bearer portion to use for Session 2 in the CS 14 runs through the media gateway 26. Since the RUA 32R acts on behalf of user element 16 in the MS 12, the RUA 32R must send the SDP for the media gateway 26 (SDP-2_{MG}) in a corresponding Invite message that is sent toward the CCF 30 through the I/S-CSCF 28 (steps 220 and 222). Remote user element 36C needs the SDP for the media gateway 26 because the packet bearer portion for the bearer path of Session 2 will extend between the media gateway 26 and remote user element 36C. Thus, packets sent from remote user element 36C toward user element 16 will be received by the media gateway 26, which will convert the packets into an appropriate CS format for delivery over the CS bearer portion. In the opposite direction, CS formatted information received from user element 16 at the media gateway 26 is converted to packet information that is delivered to remote user element 36C.

Once the CCF 30 receives the Invite message from the RUA 32R via the I/S-CSCF 28, the Invite message is processed and the new access signaling leg information is updated at the CCF 30. The CCF 30 will send a Re-Invite message toward remote user element 36C through the I/S-CSCF 28 via the remote access signaling leg to provide an update to remote user element 36C (steps 224 and 226). The update will effectively tell remote user element 36C to communicate with user element 16 via the media gateway 26 instead of directly with user element 16. At this point, the CS bearer portion is established and Session 2 has been transferred from the MS 12 to the CS 14. In the meantime, user element 16 will initiate the transfer of Session 1 from the MS 12 to the CS 14. In a fashion similar to that described above, user element 16 will provide an Invite message or information for an Invite message within an envelope of CS signaling to the VMSC 22 (step 228), which will forward the Invite message or information associated with the Invite message using CS signaling to the CAAF 32C (step 230). The CAAF 32C and the RUA 32R will process the Invite message or information associated with the Invite message (step 232) and generate an Invite message for delivery to the CCF 30 via the I/S-CSCF 28 (steps 234 and 236).

Notably, the Invite message provided by user element 16 will provide an indication that Session 1 is being held and will be delivered over what is effectively a separate access signaling path than that used for Session 2. In particular, the same USSD signaling channel may be used, but the Invite message will separately identify Session 1 (PSI_{A-B}) and will be processed by the CAAF 32C and the RUA 32R apart from the signaling associated with Session 2. The Invite message provided by the CAAF 32C or RUA 32R will include an SDP indicative of the session being held.

As with the prior communication flow, the CCF 30 does not necessarily have to update remote user element 36B immediately upon receiving the Invite message for Session 1. However, prior to Session 1 being resumed, the CCF 30 will need to provide an update to remote user element 36B, such that remote user element 36B will recognize that a domain transfer has taken place, or at least recognize the need to communicate with user element 16 via the media gateway 26 instead of directly with user element 16. As illustrated, the CCF 30 provides a relatively immediate update by sending an Invite message toward remote user element 36B through the I/S-CSCF 28 over the remote access signaling leg for Session 1 to indicate that the session is being held (steps 238 and 240). The Invite message may also identify the media gateway 26 as the new destination for communications, in case in-band communications are required to maintain the session, even through the session is being held.

At this point, both Session 1 and Session 2 have been transferred from the MS 12 to the CS 14. Further, Session 1 with remote user element 36B remains held, while Session 2 with remote user element 36C remains active. The bearer path for Session 2 extends between user element 16 and remote user element 36C via the VMSC 22 and the media gateway 26 (step 242). The CS bearer portion extends between user element 16 and the media gateway 26 through the VMSC 22, while the MS bearer portion extends between the media gateway 26 and remote user element 36C via the MS 12 or associated packet network.

Next, assume user element 16 takes the necessary action to resume Session 1 and place Session 2 on hold (step 244). In response, user element 16 will generate a Re-Invite message intended for remote user element 36C indicating that the session is being held. The Re-Invite message is placed in an envelope of CS signaling and provided to the VMSC 22 (step 246), which will forward the Re-Invite message in the CS signaling to the CAAF 32C (step 248). Again, the CAAF 32C and the RUA 32R will cooperate to extract the Re-Invite message from the CS signaling (step 250) and generate an appropriate Re-invite message, which is intended for remote user element 36C and provides an SDP to indicate that Session 2 is being held. The RUA 32R will send the Re-invite message toward the CCF 30 via the I/S-CSCF 28 (steps 252 and 254). The CCF 30 will receive the Re-invite message via the access signaling leg for Session 2 and forward the Re-invite message toward remote user element 36C through the I/S-CSCF 28 via the remote signaling leg for Session 2 (steps 256 and 258). Session 2 is now held.

To activate Session 1 between user element 16 and remote user element 36B, user element 16 will generate a Re-invite message that is sent toward remote user element 36B, wherein the Re-invite message is configured to activate the currently held Session 1. The Re-invite message is carried by CS signaling to the VMSC 22 (step 260), which will deliver the Re-Invite message via CS signaling to the CAAF 32C (step 262). Again, the CAAF 32C and the RUA 32R will cooperate to extract the Re-invite message from the CS signaling (step 264) and present a Re-invite message for delivery to the CCF 30 via the I/S-CSCF 28 (steps 266 and 268). Notably, the RUA 32R will generate the Re-invite message to include the SDP (SDP-1_{MG}) for the media gateway 26 to use for Session 1, because remote user element 36B will now need to communicate with the media gateway 26 instead of directly with user element 16. The CCF 30 will provide an update to remote user element 36B by sending a Re-invite message to remote user element 36B through the I/S-CSCF 28 via the remote access signaling leg for Session 1 (steps 270 and 272). At this point, Session 1 is active, and the bearer path for Session 1 extends between user element 16 and remote user element 36B via the VMSC 22 and the media gateway 26 (step 274). The CS bearer portion may be the same CS bearer portion used for Session 2, and extends between user element 16 and the media gateway 26 via the VMSC 22. The MS bearer portion for Session 1 may be different than the MS bearer portion for Session 2, and may extend directly between the media gateway 26 and remote user element 36B. Thus, the media gateway 26 may keep track of multiple MS bearer portions with multiple remote user elements 36B, 36C while employing a single CS bearer portion with user element 16 via the CS 14 when user element 16 is engaged in sessions with remote user elements 36B and 36C.

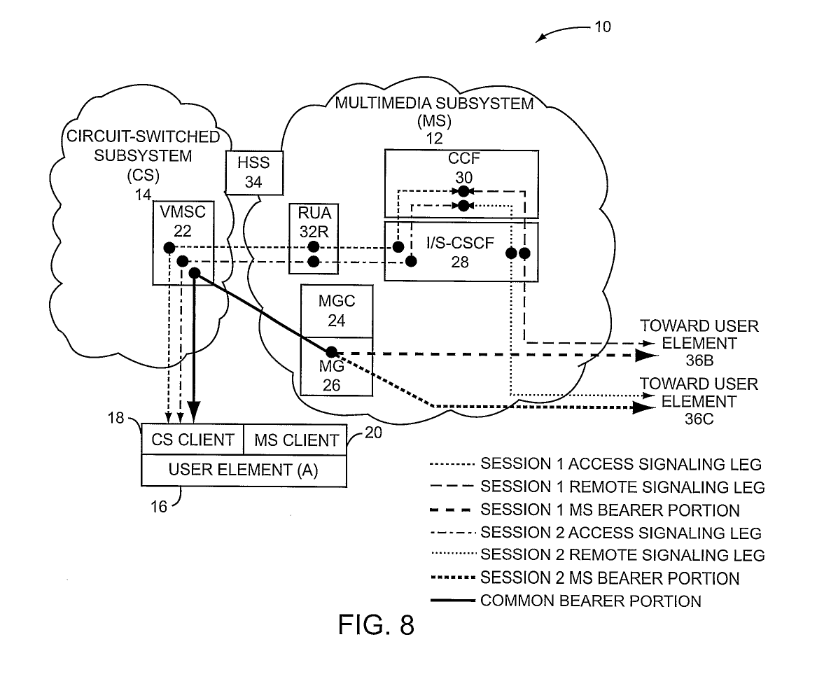

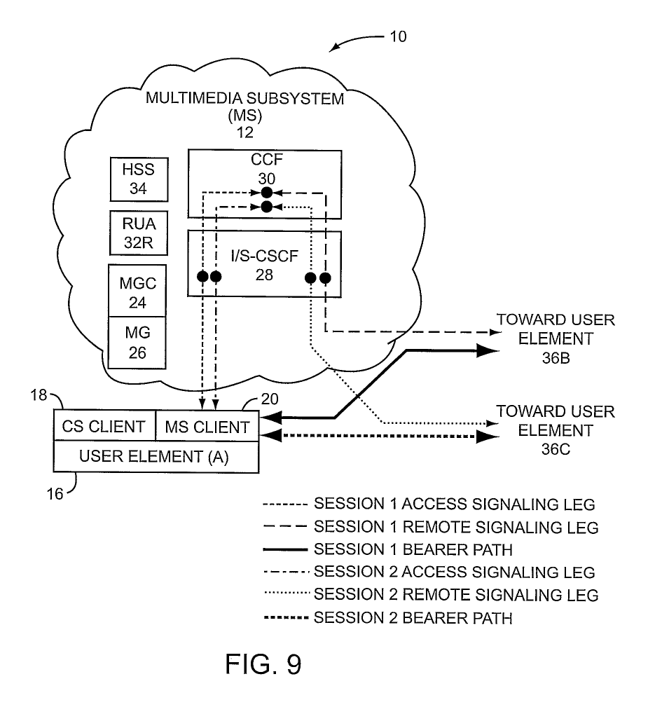

In the above embodiments, the CAAF 32C is associated with the RUA 32R and used as a signaling gateway between the CS 14 and the MS 12. With the embodiments illustrated in FIGS. 8 and 9, the CAAF 32C is not employed in environments where the CS 14 supports packet-based communications over a circuit-switched network, such as that employed in a General Packet Radio Service (GPRS), which is a packet-based wireless communication service provided by Global System for Mobile Communications (GSM) networks. In these instances, user element 16 may use GPRS or like transport for session signaling intended for or received from the MS 12 in a direct fashion, even when user element 16 is supported via the CS 14. As illustrated in FIG. 8, the access signaling legs for Session 1 and Session 2 extend between the CS client 18 of user element 16 and the CCF 30 via the VMSC 22, the RUA 32R, and the I/S-CSCF 28. The remote signaling legs for Session 1 and Session 2 are as described above. The CCF 30 anchors and associates the respective access and remote signaling legs for Session 1 and Session 2 to facilitate session control between user element 16 and remote user elements 36B and 36C, respectively. With reference to FIG. 9, the access and remote signaling legs for Session 1 and Session 2 are illustrated when user element 16 is supported by the MS 12 or like packet network.

Transfers between the CS 14 and the MS 12 effectively change the bearer paths and the signaling paths for the respective sessions from the transferring-out domain to the transferring-in domain. Thus, a transfer from the CS 14 to the MS 12 will implement a bearer path and signaling path change from what is shown in FIG. 8 to that shown in FIG. 9. For a transfer from the MS 12 to the CS 14, the bearer paths and signaling paths will change from what is shown in FIG. 9 to that shown in FIG. 8. Although only two sessions are illustrated, any number of sessions may be supported based on available resources for user element 16 and the associated networks.

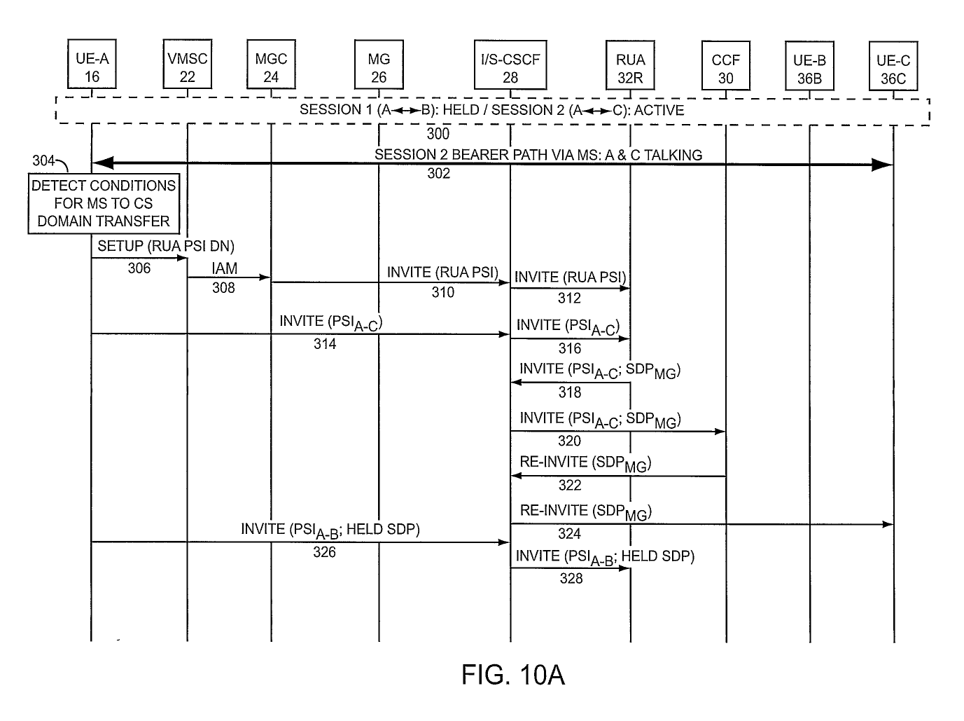

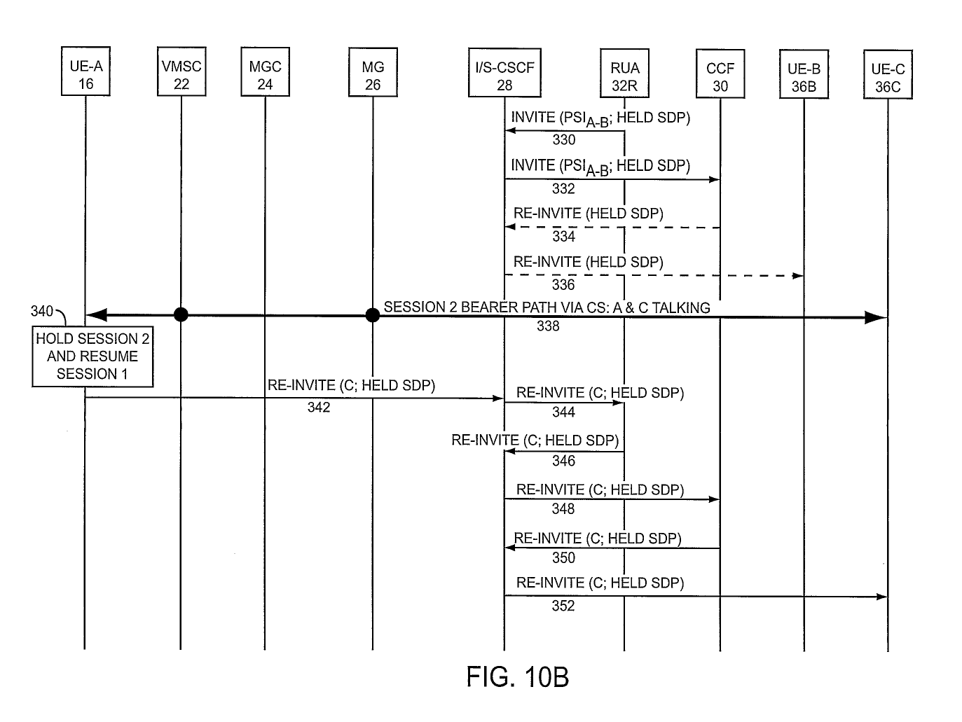

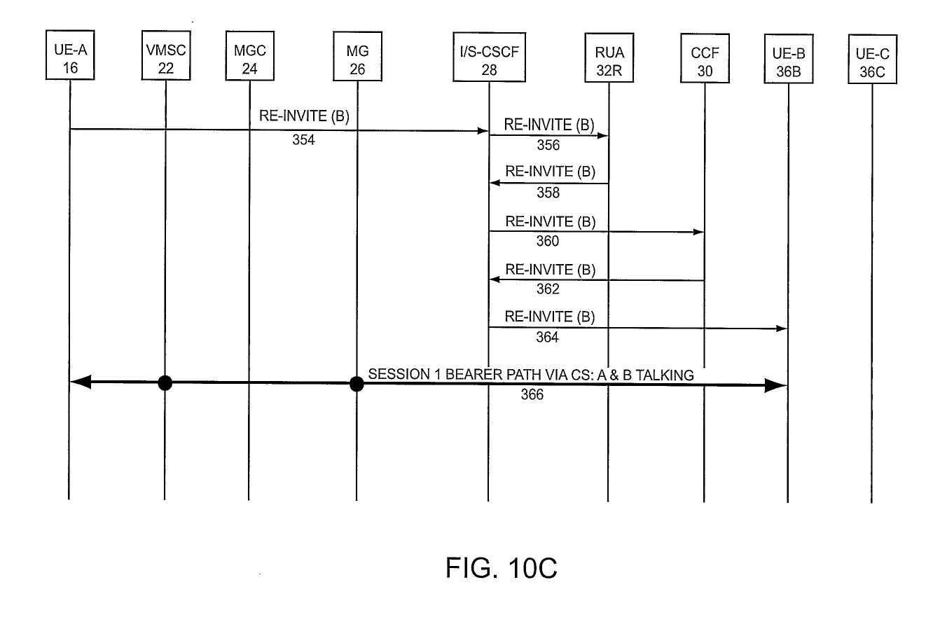

An example is illustrated in FIGS. 10A-10C, wherein user element 16 (UE-A) is engaged in two sessions. Session 1 is with remote user element 36B (UE-B) and is held, while Session 2 is with remote user element 36C (UE-C) and is active. Further assume that both Session 1 and Session 2 are supported via the MS 12, and as such, neither the bearer paths or signaling paths for the sessions extend through the CS 14, as depicted in FIG. 9. In this example, user element 16 will detect conditions requiring a domain transfer from the MS 12 to the CS 14, and initiate a domain transfer from the MS 12 to the CS 14. The MS 12 is the transferring-out domain and the CS 14 is the transferring-in domain.

Initially, user element 16 is involved in Session 1, which is held, with remote user element 36B, and is involved in Session 2, which is active, with remote user element 36C (step 300). The bearer path for Session 2 extends directly between user element 16 and remote user element 36C without traversing the CS 14 (step 302). At some point, user element 16 will detect conditions requiring a domain transfer from the MS 12 to the CS 14 (step 304). As a result, user element 16 will initiate the domain transfer to the CS 14 by taking the necessary steps to establish a CS bearer portion and associated control path with the RUA 32R through the VMSC 22. In particular, user element 16 will send a Setup message to request a CS bearer portion to the VMSC 22 (step 306). The Setup message may include a directory number (PSI) associated with the RUA 32R. The VMSC 22 will send an IAM to the media gateway controller 24 associated with the media gateway 26 (step 308). The CS bearer portion will be established between user element 16 and the media gateway 26 via the VMSC 22. The media gateway controller 24 will also alert the RUA 32R of the CS bearer portion and establish a control path for the CS bearer portion by sending an Invite message to the RUA 32R via the I/S-CSCF 28 (steps 310 and 312). The Invite message will identify the PSI of the RUA 32R to enable the Invite message to be routed to the RUA 32R via the I/S-CSCF 28. At this point, the CS bearer portion between the media gateway 26 and user element 16 is established, and an associated control path is set up through the RUA 32R.

Next, user element 16 will first initiate a domain transfer for Session 2, which is the active session, by sending an Invite message over GPRS transport toward the CCF 30 using a PSI associated with Session 2. Since GPRS transport is employed, the Invite message may be routed directly to the I/S-CSCF 28 without traversing the CAAF 32C. Thus, the Invite message is sent to the I/S-CSCF 28 (step 314), which forwards the Invite message to the RUA 32R (step 316), which acts as the remote user agent for user element 16 while user element 16 is supported by the CS 14. The RUA 32R will recognize that the CS bearer portion is anchored at the media gateway 26, and acting on behalf of user element 16 will generate an Invite message for delivery to the CCF 30 that includes the SDP for the media gateway 26 (SDPMG). The SDP for the media gateway 26 will include the communication parameters necessary for remote user element 36C to use when communicating with the media gateway 26. The RUA 32R will generate an Invite message with the SDP for the media gateway 26 and forward the Invite message to the CCF 30 through the I/S-CSCF 28 using the PSI for Session 2 (steps 318 and 320). The Invite message provided by user element 16 may include the state information associated with Session 2 while it was being supported in the MS 12. The CCF 30 may keep track of the state information, as well as forward the state information to remote user element 36C. The CCF 30 will send a Re-Invite message toward remote user element 36C through the I/S-CSCF 28 via the remote signaling leg for Session 2 (steps 322 and 324). The Re-Invite will include the SDP for the media gateway 26, along with any necessary state information originally provided by user element 16 to remote user element 36C. Any acknowledgements or subsequent session signaling will be provided over the signaling path provided by the new access signaling leg through the CS 14 and the remote access leg for Session 1.

In the meantime, user element 16 will initiate the transfer of Session 1 from the MS 12 to the CS 14. As such, user element 16 will generate an Invite message with any requisite state information for Session 1, and send the Invite message into the MS 12 using a PSI associated with Session 1 (step 326). The state information in this instance may indicate that Session 1 is being held by providing an SDP indicating the held status. The Invite message is received in the MS 12 at the I/S-CSCF 28 and forwarded to the RUA 32R, which is acting on behalf of user element 16 while user element 16 is being served by the CS 14 (step 328). The RUA 32R will forward the Invite message toward the CCF 30 via the I/S-CSCF 28 (steps 330 and 332). The CCF 30 will update the state information for Session 1, and may initiate a Re-Invite toward remote user element 36B through the I/S-CSCF 28 over the remote signaling leg (steps 334 and 336). The Re-Invite message may include the SDP indicating that the session remains on hold, and if in-band signaling is required for the held session, the SDP for the media gateway 26, such that remote user element 36B will communicate with the media gateway 26 over the bearer path for Session 2 instead of directly with user element 16.

At this point, Session 2 is active and the bearer path for Session 2 extends to user element 16 via the CS 14 (step 338). In particular, the CS bearer portion of the bearer path extends between user element 16 and the media gateway 26 via the VMSC 22, while the MS portion of the bearer path extends between the media gateway 26 and remote user element 36C. Session 1 remains held.

As with the above examples, assume that the user associated with user element 16 decides to resume Session 1 and place Session 2 on hold (step 340). At this point, both Session 1 and Session 2 are supported via the CS 14, and as such, user element 16 will initiate a Re-Invite message for remote user element 36C, wherein the Re-Invite message provides an indication to place Session 2 on hold. In this example, the held indication is provided by sending an SDP indicating the session is being placed on hold. The Re-Invite message is delivered directly into the MS 12 using GPRS transport, and is received by the I/S-CSCF 28 (step 342). The Re-Invite message is delivered to the RUA 32R (step 344), which acting on behalf of user element 16 will forward the Re-Invite message to the CCF 30 via the I/S-CSCF 28 (steps 346 and 348). The CCF 30 will update its state information for Session 2, and deliver a Re-Invite message toward remote user element 36C through the I/S-CSCF 28 over the remote signaling leg (steps 350 and 352). The Re-Invite message will include the SDP that indicates that Session 2 is being held.

Next, user element 16 will resume Session 1 with remote user element 36B. To do so, user element 16 will send a Re-Invite message intended for remote user element 36B into the MS 12 over the access signaling leg for Session 1 using GPRS transport (step 354). The I/S-CSCF 28 will forward the Re-Invite message to the RUA 32R (step 356), which acting on behalf of user element 16 will forward the Re-Invite message to the CCF 30 via the I/S-CSCF 28 (steps 358 and 360). The CCF 30 will update any associated state information based on the state information provided by user element 16, and initiate a Re-invite message toward remote user element 36B through the I/S-CSCF 28 via the remote signaling leg for Session 1 (steps 362 and 364). The Re-invite message initiated by the RUA 32R may include the SDP for the media gateway 26, if such information was not already provided. Remote user element 36B will recognize the Re-invite message as an instruction to resume Session 1, and will recognize that the bearer path for Session 1 runs through the media gateway 26. At this point, a bearer path extends between user element 16 and remote user element 36B through the VMSC 22 and media gateway 26 (step 366). The CS bearer portion extends between the media gateway 26 and user element 16 through the VMSC 22, while the MS portion of the bearer path extends between the media gateway 26 and remote user element 36B. Session 1 is now active, and Session 2 has been placed on hold.

For this embodiment, the process is substantially the same as that provided in association with FIGS. 6A and 6B. In essence, the removal of the CAAF 32C and the use of GPRS transport or the like bears little significance when transferring into the MS 12, since the access signaling paths are transitioned out of the CS 14 and run directly into the CCF 30 via the I/S-CSCF 28 without employing the RUA 32R.

In the above examples, one of the multiple sessions currently being supported by user element 16 is maintained in a held state; however, those skilled in the art will recognize that multiple sessions may be transitioned from one domain to another, wherein each of the sessions is active and remains active across the domain transfer. The examples where one or more sessions are held merely represents the more complicated scenario where the sessions are voice sessions and are treated accordingly to avoid having multiple active voice sessions at any given time. When multiple sessions are active and user element 16 is being supported by the CS 14, multiple CS bearer portions through the CS 14 may be provided such that each session has a corresponding CS bearer portion. Alternatively, the single CS bearer portion may be shared for the multiple active sessions.

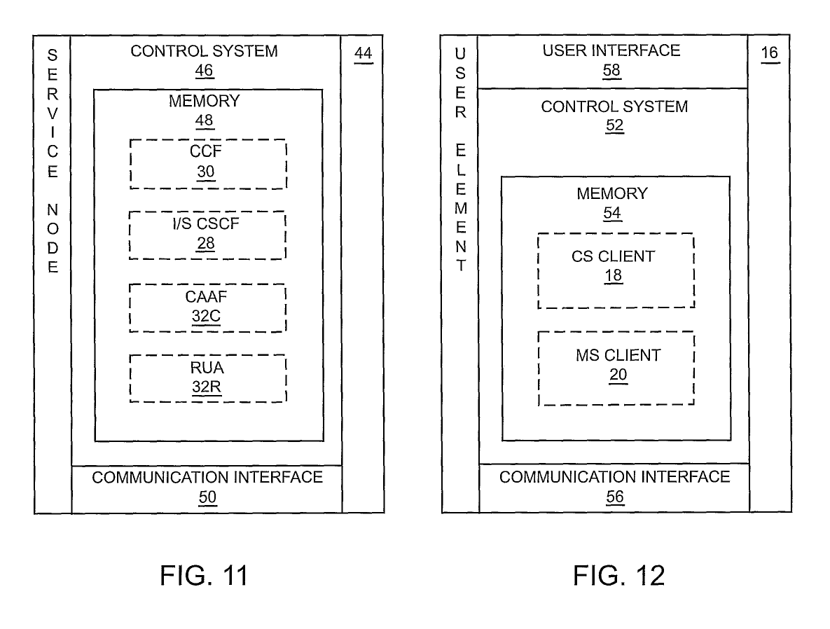

With reference to FIG. 11, a service node 44 is provided according to one embodiment of the present invention. The service node 44 may reside in the MS 12 and include a control system 46 and associated memory 48 to provide the functionality for any one or a combination of the following: the CCF 30, the I/S-CSCF 28, the CAAF 32C, and the RUA 32R. The control system 46 will also be associated with a communication interface 50 to facilitate communications with any entity affiliated with the MS 12 or associated networks.

With reference to FIG. 12, a block representation of a user element 16 is provided. The user element 16 may include a control system 52 having sufficient memory 54 to support operation of the CS client 18 and the MS client 20. The control system 52 will cooperate closely with a communication interface 56 to allow the CS client 18 and the MS client 20 to facilitate communications over the CS 14 or the MS 12 as described above. The control system 52 may also be associated with a user interface 58, which will facilitate interaction with the user. The user interface 58 may include a microphone and speaker to facilitate voice communications with the user, as well as a keypad and display to allow the user to input and view information.

Those skilled in the art will recognize improvements and modifications to the preferred embodiments of the present invention. All such improvements and modifications are considered within the scope of the concepts disclosed herein and the claims that follow.

What is claimed is:

1. A method facilitating domain transfers for a user element simultaneously engaged in a plurality of sessions comprising:
providing a plurality of session signaling paths for a corresponding plurality of sessions, each of the plurality of session signaling paths comprising a first access signaling leg and a remote access signaling leg for a corresponding one of the plurality of sessions, wherein the first access signaling leg for each of the plurality of session signaling paths is anchored at a control function residing in a multimedia subsystem and extends toward a first user element via a transferring-out domain; and
for each of the plurality of sessions:
providing a second access signaling leg that is anchored at the control function and extends toward the first user element via a transferring-in domain;
replacing the first access signaling leg with the second access signaling leg; and
exchanging session signaling between the second access signaling leg and the remote signaling leg to provide an updated session signaling path to facilitate session signaling for the first user element while the first user element is served by the transferring-in domain.

2. The method of claim 1 further comprising for each of the plurality of sessions, effecting transfer of at least a portion of a bearer path connected to the first user element from a first network associated with the transferring-out domain to a second network associated with the transferring-in domain.

3. The method of claim 1 further comprising receiving from the first user element a request for a domain transfer via the transferring-in domain and providing the second access signaling leg for each of the plurality of sessions in response to receiving the request.

4. The method of claim 3 wherein the request is generated from the first user element when the first user element determines a need to transfer the plurality of sessions from the transferring-out domain to the transferring-in domain.

5. The method of claim 3 wherein the request is originated from the first user element using at least one of a multimedia subsystem address for the control function and a directory number within a circuit-switched subsystem, which is associated with the multimedia subsystem address.

6. The method of claim 1 wherein one of the first access signaling leg and the second access signaling leg for each of the plurality of session signaling paths extend into a circuit-switched subsystem through a remote user agent that presents itself as the first user element to the multimedia subsystem when the first user element is served by the circuit-switched subsystem.

7. The method of claim 6 wherein another of the first access signaling leg and the second access signaling leg for each of the plurality of session signaling paths extend to the first user element without traversing the circuit-switched subsystem.

8. The method of claim 6 wherein a Circuit-Switched Subsystem Access Adaptation Function resides between the remote user agent and a mobile switching center that serves the first user element along the one of the first access signaling leg and the second access signaling leg for each of the plurality of session signaling paths, the Circuit-Switched Subsystem Access Adaptation Function providing signaling conversion between the circuit-switched subsystem and the multimedia subsystem.

9. The method of claim 8 wherein session signaling messages for use in the multimedia subsystem are carried in circuit-switched subsystem signaling to the Circuit-Switched Subsystem Access Adaptation Function via the one of the first access signaling leg and the second access signaling leg for each of the plurality of session signaling paths.

10. The method of claim 9 wherein the circuit-switched subsystem signaling is provided at least in part in an Unstructured Supplementary Service Data channel.

11. The method of claim 8 wherein session signaling messages for use in the multimedia subsystem are carried over a packet transport mechanism provided by the circuit-switched subsystem via the one of the first access signaling leg and the second access signaling leg for each of the plurality of session signaling paths.

12. The method of claim 11 wherein the packet transport mechanism is a General Packet Radio Service in a Global System for Mobile Communications network.

13. The method of claim 1 wherein an active session and a held session of the plurality of sessions are voice sessions, and transfer of the active session is initiated prior to initiating transfer of the held session to the transferring-in domain.

14. The method of claim 1 wherein one of the transferring-in domain and the transferring-out domain is the multimedia subsystem and another of the transferring-in domain and the transferring-out domain is a circuit-switched subsystem.

15. The method of claim 14 wherein access to the one of the transferring-in domain and the transferring-out domain is provided via wireless access outside of the circuit-switched subsystem.

16. The method of claim 15 wherein the wireless access supports packet-based communications and the circuit-switched subsystem supports circuit-switched communications.

17. The method of claim 14 wherein the circuit-switched subsystem is provided by a cellular network.

18. The method of claim 1 wherein the plurality of sessions are associated with a corresponding plurality of unique bearer paths.

19. The method of claim 18 wherein first portions of the plurality of unique bearer paths that are supported by a multimedia subsystem are separate from one another within the multimedia subsystem.

20. The method of claim 19 wherein when the plurality of sessions are supported at least in part by a circuit-switched subsystem, the unique bearer path for each of the plurality of sessions is supported by a common circuit-switched bearer portion that extends through the circuit-switched subsystem to the first user element.

21. The method of claim 1 wherein each of the plurality of sessions is connected between the first user element and a different one of a plurality of remote endpoints.

22. The method of claim 1 wherein when one of the plurality of sessions is originated from the first user element, the control function is invoked as a first service of a plurality of services to be provided in one of the plurality of session signaling paths formed by the first access signaling leg and the remote signaling leg, such that all of the plurality of services other than the continuity control function are provided in the remote signaling leg, and the remote signaling leg is anchored at the control function.

23. The method of claim 1 wherein when one of the plurality of sessions is terminated at the first user element, the control function is invoked as a last service of a plurality of services to be provided in one of the plurality of session signaling paths formed by the first access signaling leg and the remote signaling leg, such that all of the plurality of services other than the control function are provided in the remote signaling leg, and the remote signaling leg is anchored at the control function.

24. The method of claim 1 wherein the control function is invoked as a service by a serving call/session control function for sessions from or intended for the first user element.

25. A method facilitating domain transfers for a user element simultaneously engaged in a plurality of sessions comprising:
anchoring at a control function residing in a multimedia subsystem the first access signaling leg for each of a plurality of session signaling paths for a corresponding plurality of sessions, wherein each of the plurality of session signaling paths comprises a first access signaling leg and a remote access signaling leg for a corresponding one of the plurality of sessions, and wherein the first access signaling leg for each of the plurality of session signaling paths extends toward a first user element via a transferring-out domain; and
for each of the plurality of sessions:
anchoring at the control function a second access signaling leg that extends toward the first user element via a transferring-in domain;
replacing the first access signaling leg with the second access signaling leg; and
exchanging session signaling between the second access signaling leg and the remote signaling leg to provide an updated session signaling path to facilitate session signaling for the first user element while the first user element is served by the transferring-in domain.
